(19) United States
(12) Patent Application Publication
(10) Pub. No.: US 2016/0347401 A1
(43) Pub. Date: Dec. 1, 2016

(54) WHEEL FORK

(71) Applicant: Croozer GmbH, Koln (DE)

(72) Inventors: Herbert WEBER, Breitbrunn (DE); Andreas GEHLEN, Koln (DE)

(21) Appl. No.: 15/165,190

(22) Filed: May 26, 2016

(30) Foreign Application Priority Data
May 28, 2015 (DE) 10 2015 108 474.0

(51) Int. Cl. B62K 27/00; B62K 27/12

(52) U.S. Cl. CPC B62K 27/006; B62K 27/12

(57) ABSTRACT

A wheel fork, in particular for a jogger function of a multifunctional bicycle trailer, is provided with at least one fork arm (1, 2). A dropout (3, 4) is formed at the free end of the at least one fork arm to receive a wheel axle of a wheel (8). A system is also provided including a wheel fork and a wheel axle which interacts with the wheel fork. To provide a wheel fork which makes possible improved travel in a straight line, at least one device is provided for adjusting the wheel fork with a directional component in the direction of travel.

### CROSS-REFERENCE TO RELATED APPLICATION

This application claims priority to German patent application 10 2015 108 474.0, filed May 28, 2015, the disclosure of which is incorporated herein by reference.

### BACKGROUND OF THE INVENTION

The present invention relates to a front wheel fork for a multifunctional bicycle trailer, the fork having two fork arms, on the front ends of which, viewed in the direction of travel, a dropout is formed in each case to receive a wheel axle of a wheel.

Multifunctional bicycle trailers, in particular ones designed for transporting children, are becoming increasingly popular due to their versatility in terms of possible uses. For example, they can be converted into a so-called jogger or stroller by removing or folding away the drawbar and fitting a forward-projecting front wheel fork, consisting of two separate fork arms, to the vehicle chassis of the bicycle trailer.

With the forward-projecting fork arms of known multifunctional bicycle trailers, the problem can arise in their function as a so-called “jogger” or “stroller” that the track of the front wheel does not run exactly parallel to the longitudinal axis of the bicycle trailer, but at a slight angle to this. Since the two fork arms are usually mounted separately to the chassis of the bicycle trailer, the position of the fork arms relative to one another can often vary following removal and refitting. This means that the track of the front wheel needs to be repeatedly readjusted in that the front wheel, which is usually fitted with a quick release fixture, is fitted as straight as possible into the slots provided in the fork to accommodate the wheel axle, the dropouts, which are open to the front in the direction of travel. If this is not done with sufficient precision, in the worst case the user pushing the bicycle trailer will need to correct the direction of travel frequently.

### BRIEF SUMMARY OF THE INVENTION

One object of the present invention is to provide a front wheel fork of the type described above which makes possible improved travel in a straight line.

This object is achieved in a front wheel fork of the type described at the outset through at least one device for adjusting the wheel axle in the direction of travel, wherein the wheel axle is preferably continuously adjustable.

Adjustment of the wheel axle in the direction of travel is to be understood, here and in the following, to refer either to a change in the position of the dropout, having a directional component in the direction of travel, in relation to the chassis of the bicycle trailer, or also to the displacement of the wheel axle within the dropout having a directional component in the direction of travel.

If at least one dropout of the two fork arms is adjustable in the direction of travel, the track of the front wheel can be adjusted exactly, and the underlying problem thus solved in a surprisingly simple manner.

In a particularly preferred embodiment of the invention, a fork arm end piece, which can in particular be tubular or cylindrical in form, and a dropout element, in or on which the dropout is formed, are provided on the front end of a fork arm, wherein the dropout element is, as a device for adjusting the dropout, mounted on or in the fork arm end piece so as to be axially displaceable. This embodiment has the particular advantage that the wheel axle does not need to be positioned within the dropout and can first be fitted and secured in the dropout before the dropout is adjusted in terms of its position relative to the fork arm end piece.

Preferably, in this embodiment according to the invention, at least one guide pin arranged transversely to the fork arm end piece is mounted on one of either the dropout element or the fork arm end piece, and at least one guide for the guide pin is provided on the other, respectively, of the dropout element or fork arm end piece which has a directional component running axially relative to the fork arm end piece. The position of the dropout element in the fork arm end piece can then be adjusted by the guide pin guided in the guide.

Another embodiment according to the invention is characterized in that the dropout forms a receiving slot for the wheel axle with a directional component extending in the direction of travel, and by a stop element extending into the fork mounting which, as a device for adjusting the dropout in the direction of travel, forms a front and/or rear (in relation to the direction of travel) wheel axis support surface and is adjustable within the dropout. In this embodiment, the position of the wheel axle is defined by the stop element(s). The positioning of the stop element(s) takes place before the wheel axle is fixed in the dropout, for example by a quick-release fixture.

In a simple exemplary variant of this embodiment, the stop element is a threaded pin, which is screwed into a threaded bore in a region between the flanks of the dropout element limiting the dropout, the free end of which offers a stop surface for a wheel axle.

Preferably, the stop element is coupled with a guide pin, wherein a guide is provided for the guide pin in a fork arm end piece of the wheel fork or in the dropout which has a directional component running axially relative to the fork arm end piece. The position of the stop element(s) can then be adjusted by the guide pin guided in the guide.

In a simple embodiment, the guide for the guide pin can run exclusively in the axial direction. In a preferred embodiment, the guide pin is mounted rotatably, and the guide describes a spiral-formed section. The smaller the pitch of the spiral-formed section in the axial direction, the more easily and precisely the track of the wheel can be adjusted.

In a further preferred embodiment, the guide pin is solidly connected with a jacket element, which at least partially encloses the fork arm end piece and a part of the dropout, wherein depending on the embodiment the jacket element can be movable in either the axial or the peripheral direction. A jacket element is easier to handle, in order to adjust the track of the wheel, than a simple pin.

Preferably, the jacket element is guided in a bearing bed recessed in the housing wall of the dropout and thus fixed in position in relation to the housing wall of the dropout.

According to a further preferred variant of the invention, a jacket element can also be equipped with a snap-locking mechanism by which it can be locked in a particular position. A snap-locking mechanism could, for example, be designed such that an axially displaceable jacket element can be brought into a snap-locked position through a rotation around its longitudinal axis and released again through rotation in the opposite direction. Accordingly, the snap-locking mechanism could also be designed such that a rotatably guided jacket element is locked in position through a short axial displacement and released again on being displaced in the opposite direction. Naturally, a snap-locking mechanism for a jacket element is not absolutely essential. It is also conceivable, but less convenient, to clamp a guide pin projecting from the wheel fork in a particular position, preventing displacement, by a collar clamp passed around the dropout.

Alternatively, the dropout and fork arm end piece can be connected together so firmly by a frictional connection that the dropout maintains its position relative to the fork arm end piece, even under the influence of forces acting when the vehicle is in motion. In this case, an active fixing in position by suitable means can be dispensed with.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a wheel fork according to an embodiment of the invention as a front wheel fork for a multifunctional bicycle trailer having a jogger function, together with a front wheel fitted therein;

FIG. 2 is a perspective view of an axle holder serving as a dropout of the wheel fork according to an embodiment of the invention together with an attached fork arm end piece;

FIG. 3 is a side view of the axle holder illustrated in FIG. 2 without the jacket element illustrated therein;

FIG. 4 is a side view of the axle holder illustrated in FIG. 3 showing the front half of the housing, as seen in this view; and

FIG. 5 is the same view as shown in FIG. 4 without the fork arm end piece.

### DETAILED DESCRIPTION OF THE INVENTION

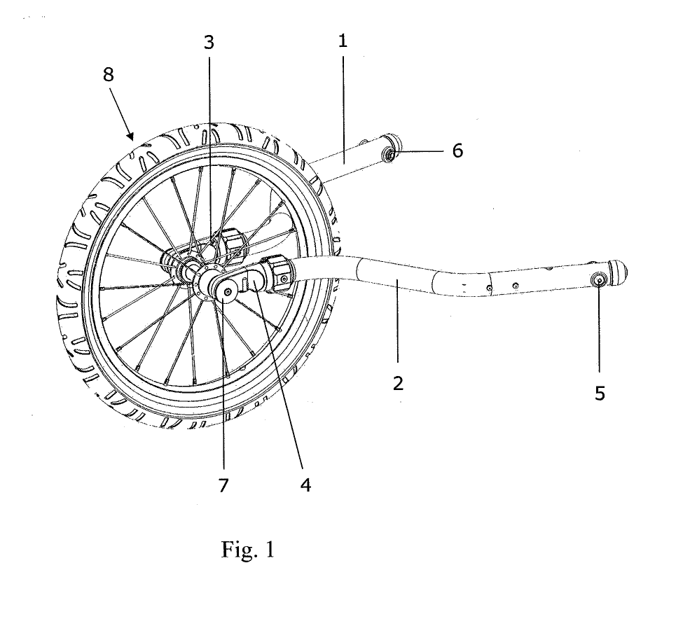

FIG. 1 shows a wheel fork according to an embodiment of the invention used for the jogger or stroller function of a multifunctional bicycle trailer. It has a right fork arm 1 and a left fork arm 2. Axle holders 3, 4 are provided on the front ends of the fork arms 1, 2, which each perform the function of a dropout. At their rear ends the fork arms have lateral pins 5, 6, which serve to attach the fork arms 3, 4 in guides provided for this purpose on a chassis of a bicycle trailer, which is not shown here. The axle holders hold the wheel axle 7 of a front wheel 8 of the bicycle trailer with jogger function.

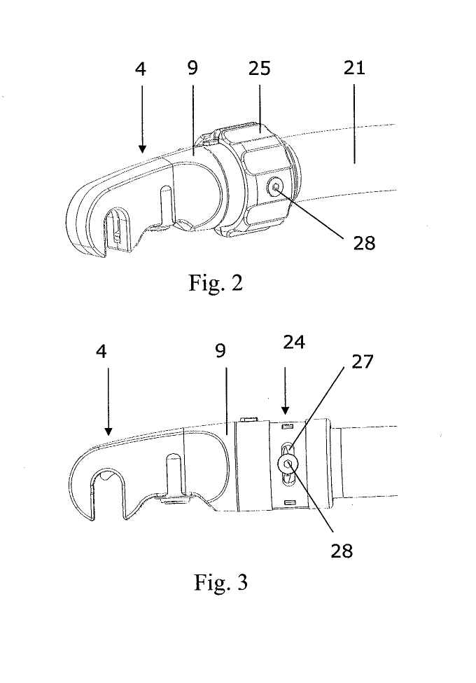

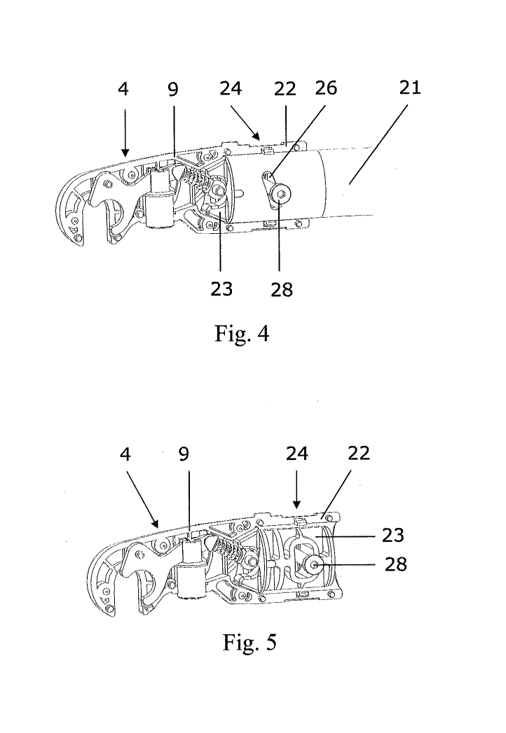

The connection between the fork arm end piece 21 of the fork tube 2 and the axle holder 4 of the wheel fork shown in FIG. 1 is explained in more detail with reference to the FIGS. 2 to 5. The fork arm end piece 21 sits in an open end 22 of the housing 9 of the axle holder 4, wherein the housing wall completely surrounds the fork arm end piece 22. A plastic body 23 sits within the fork arm end piece in order to stabilize the fork arm end piece 22 against the forces transferred into the fork arm end piece 22 from the axle holder 4. A peripheral bearing bed 24 for a peripheral jacket element 25 is recessed into the outer side of the housing wall, the jacket being freely rotatable around the housing within the bearing bed 24.

Corresponding spiral-formed guides 26 having a constant pitch in axial direction are recessed into the fork arm end piece 22 on opposite sides. Guide openings 27 are also provided in the bearing bed 24 of the housing wall on opposite sections which do not, however, display any pitch in an axial direction. A guide pin 28 is provided, the width of which corresponds to the width of the guides 26 and the guide openings 27. The guide pin 28 extends through the guide openings 27, the guides 26 and the plastic body 23. Its ends are screwed into the jacket element 25. If the jacket element 25 is rotated around the housing wall in the bearing bed 24, the guide pin 28 runs both along the guides 26 in the fork arm end piece 22 with axial pitch and also along the guide openings 27 of the housing wall without axial pitch.

As a result, the housing wall is displaced axially relative to the fork arm end piece. In consequence, it is possible to change the position of the axle holder 4 in the axial direction and so to adjust the track of the front wheel 8 held by the wheel fork. The same result can be achieved if the guide openings in the bearing bed of the housing wall have an axial pitch, and the guides in the fork arm end piece do not, or if the guide openings in the bearing bed of the housing wall and the guides in the fork arm end piece have different axial pitches. Other embodiments having individual pins fixed in position on the housing wall or the fork arm end piece and guides provided for this purpose with axial components in the other component in each case are also possible.

The jacket element 25 has on its inner side a section having an elastic ribbed structure, which interacts with a corresponding ribbed structure on the outer side of the housing wall and counteracts an unintentional twisting of the jacket element 25.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A front wheel fork for a multifunctional bicycle trailer, the wheel fork comprising:
two fork arms, each having a front end viewed in a direction of travel, each fork arm front end including a dropout formed to receive a wheel axle of a wheel, and
at least one device configured to adjust the wheel axle with a directional component in the direction of travel.

2. The front wheel fork according to claim 1, wherein the adjusting device is designed such that adjustment of the wheel axle is continuous.

3. The front wheel fork according to claim 1, wherein each fork arm front end further includes a fork arm end piece and a dropout element in or on which the dropout is formed, wherein the dropout element comprises a device configured to adjust the dropout and is mounted on or in the fork arm end piece so as to be axially displaceable.

4. The front wheel fork according to claim 3, further comprising:
at least one guide pin arranged transversely to the fork arm end piece and mounted on one of either the dropout element or the fork arm end piece, and
at least one guide for the guide pin, wherein the guide pin is provided on whichever one of the dropout element or the fork arm end piece on which the at least one guide pin is not mounted, and which has a directional component running axially relative to the fork arm end piece.

5. The front wheel fork according to claim 1, wherein the dropout forms a receiving slot for the wheel axle having a directional component extending in the direction of travel, and further comprising a stop element extending into the fork mounting and configured to adjust the dropout in the direction of travel, the stop element forming a front and/or rear wheel axis support surface in relation to the direction of travel and being adjustable within the dropout.

6. The front wheel fork according to claim 5, wherein the stop element is coupled with a guide pin, and further comprising a guide for the guide pin, the guide being provided in a fork arm end piece in which the dropout is formed or on the dropout element containing the dropout, and the guide having a directional component running axially relative to the fork arm end piece.

7. The front wheel fork according to claim 4, wherein the at least one guide pin is mounted rotatably, and the at least one guide describes a spiral-formed section.

8. The front wheel fork according to claim 4, wherein the guide pin is solidly connected with a jacket element which at least partially encloses the fork arm end piece and/or the dropout element.

9. The front wheel fork according to claim 8, wherein the jacket element is guided in a bearing bed recessed in a housing wall of the dropout element.

10. The front wheel fork according to claim 8, wherein the jacket element is enabled to be locked in position by a snap-locking mechanism.
